(19) United States
(12) Patent Application Publication
(10) Pub. No.: US 2016/0226545 A1
(43) Pub. Date: Aug. 4, 2016

(54) COMMUNICATION DEVICE

(71) Applicant: Quanta Computer Inc., Taoyuan City (TW)

(72) Inventors: Chin-Lung TSAI, Taoyuan City (TW); Chung-Ting HUNG, Taoyuan City (TW); Ying-Cong DENG, Taoyuan City (TW); Chung-Hung LO, Taoyuan City (TW); Kuan-Hsien LEE, Taoyuan City (TW)

(21) Appl. No.: 14/700,484

(22) Filed: Apr. 30, 2015

(30) Foreign Application Priority Data
Jan. 29, 2015 (TW) 104102968

(51) Int. Cl. H04B 1/3827; H01Q 1/24

(52) U.S. Cl. CPC H04B 1/3838; H01Q 1/241; H04W 88/06

(57) ABSTRACT

A communication device includes a radiation element, an RF (Radio Frequency) choke element, a DC (Direct Current) block element, an SAR (Specific Absorption Rate) sensor, a transceiver, and a platform. The radiation element has the functions of an antenna and a sensing pad. The radiation element is configured to receive a low-frequency signal and an RF signal. The RF choke element is configured to remove the RF signal. The DC block element is configured to remove the low-frequency signal. The radiation element is coupled through the RF choke element to the SAR sensor. The radiation element is further coupled through the DC block element to the transceiver. The platform is coupled to the SAR sensor and the transceiver.

### CROSS REFERENCE TO RELATED APPLICATIONS

This application claims priority of Taiwan Patent Application No. 104102968 filed on Jan. 29, 2015, the entirety of which is incorporated by reference herein.

### BACKGROUND OF THE INVENTION

1. Field of the Invention

The disclosure generally relates to a communication device, and more specifically, to a communication device with a radiation element configured as both an antenna and a sensing pad.

2. Description of the Related Art

With the progress of mobile communication technology, mobile devices, for example, portable computers, mobile phones, tablet computers, multimedia players, and other hybrid functional portable electronic devices, have become more common. To satisfy the needs of users, mobile devices can usually perform wireless communication functions. Some functions cover a large wireless communication area; for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area; for example, mobile phones using Wi-Fi and Bluetooth systems and using frequency bands of 2.4 GHz, 5.2 GHz, and 5.8 GHz.

A conventional mobile device usually includes an antenna and a sensing pad, which are separate from each other, so as to support wireless communication and adjustment of radiation power. However, since there is limited space in a mobile device, the aforementioned antenna and sensing pad may be very close to each other, and this can lead to interference and poor radiation efficiency of the antenna. Accordingly, there is a need to design a novel mobile communication device for solving the problem of the prior art.

### BRIEF SUMMARY OF THE INVENTION

In a preferred embodiment, the invention provides a communication device including a radiation element, an RF (Radio Frequency) choke element, a DC (Direct Current) block element, an SAR (Specific Absorption Rate) sensor, a transceiver, and a platform. The radiation element has the functions of both an antenna and a sensing pad. The radiation element is configured to receive a low-frequency signal and an RF signal. The RF choke element is configured to remove the RF signal. The DC block element is configured to remove the low-frequency signal. The radiation element is coupled through the RF choke element to the SAR sensor. The radiation element is further coupled through the DC block element to the transceiver. The platform is coupled to the SAR sensor and the transceiver.

In some embodiments, the SAR sensor is configured to process the low-frequency signal and obtain SAR information thereof accordingly.

In some embodiments, when a human body is close to the radiation element, an effective capacitance is formed between the radiation element and the human body. The low-frequency signal includes information of the effective capacitance.

In some embodiments, the transceiver is configured to process the RF signal and obtain a communication content thereof accordingly.

In some embodiments, the RF choke element includes an inductor, and the inductor has a relatively large inductance.

In some embodiments, the DC block element includes a capacitor, and the capacitor has a relatively large capacitance.

In some embodiments, the radiation element is further coupled to a ground voltage.

In some embodiments, the radiation element and the DC block element are implemented with a first metal element and a second metal element. The first metal element is separate from the second metal element.

In some embodiments, the first metal element is close to the second metal element, and a coupling gap is formed between the first metal element and the second metal element.

In some embodiments, the second metal element is coupled to the RF choke element and a ground voltage.

### BRIEF DESCRIPTION OF DRAWINGS

The invention can be more fully understood by reading the subsequent detailed description and examples with references made to the accompanying drawings, wherein:

FIG. 1 is a diagram of a communication device according to an embodiment of the invention;

FIG. 2 is a diagram of measurement of an effective capacitance according to an embodiment of the invention;

FIG. 3 is a diagram of an RF (Radio Frequency) choke element according to an embodiment of the invention;

FIG. 4 is a diagram of an RF choke element according to an embodiment of the invention;

FIG. 5 is a diagram of a DC (Direct Current) block element according to an embodiment of the invention;

FIG. 6 is a diagram of a DC block element according to an embodiment of the invention;

FIG. 7 is a diagram of a communication device according to an embodiment of the invention;

FIG. 8 is a diagram of a communication device according to an embodiment of the invention; and

FIG. 9 is a diagram of a communication device according to an embodiment of the invention.

### DETAILED DESCRIPTION OF THE INVENTION

In order to illustrate the purposes, features and advantages of the invention, the embodiments and figures of the invention are shown in detail as follows.

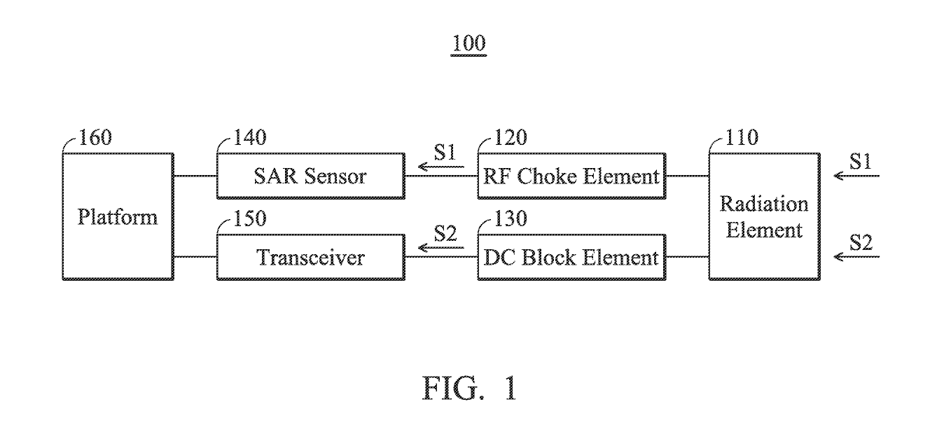

FIG. 1 is a diagram of a communication device 100 according to an embodiment of the invention. The communication device 100 may be a mobile device with a communication function, such as a smart phone, a tablet computer, or a notebook computer. As shown in FIG. 1, the communication device 100 includes a radiation element 110, an RF (Radio Frequency) choke element 120, a DC (Direct Current) block element 130, an SAR (Specific Absorption Rate) sensor 140, a transceiver 150, and a platform 160. It should be understood that the communication device 100 may further include other elements, such as a battery, a display device, a touch control module, a speaker, and/or a housing (not shown), although they are not displayed in FIG. 1.

The radiation element 110 may be made of a conductive material, such as copper, silver, aluminum, iron, or their alloy. The shape and size of the radiation element 110 are not limited in the invention. For example, the radiation element 110 may substantially have a straight-line shape, a loop shape, or an inverted F-shape. The radiation element 110 has the functions of both an antenna and a sensing pad. The radiation element 110 is configured to receive a low-frequency signal Si and an RF signal S2. In some embodiments, the low-frequency signal S1 is a DC signal (i.e., its frequency is zero), and the RF signal S2 has a frequency which is higher than 700 MHz. For example, the RF signal S2 may be a mobile communication signal, such as an LTE (Long Term Evolution) signal, a 3G signal, or a GSM (Global System for Mobile Communication) signal.

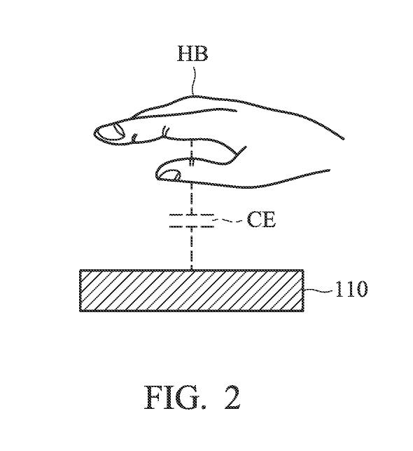

FIG. 2 is a diagram of measurement of an effective capacitance CE according to an embodiment of the invention. As shown in FIG. 2, when a human body HB (or a conductor) is close to the radiation element 110, an effective capacitance CE is formed between the radiation element 110 and the human body HB. The aforementioned low-frequency signal S1 may include the information of the effective capacitance CE. By analyzing the information of the effective capacitance CE from the low-frequency signal S1, the spacing between the human body HB and the communication device 100 can be obtained, and therefore the corresponding SAR value can be calculated.

The RF choke element 120 is configured to remove the RF signal S2. The radiation element 110 is coupled through the RF choke element 120 to the SAR sensor 140, such that the SAR sensor 140 can receive only the low-frequency signal S1 from the radiation element 110. The SAR sensor 140 is configured to process the low-frequency signal S1 and obtain its SAR information accordingly. The DC block element 130 is configured to remove the low-frequency signal S1. The radiation element 110 is further coupled through the DC block element 130 to the transceiver 150, such that the transceiver 150 can receive only the RF signal S2 from the radiation element 110. The transceiver 150 is configured to process the RF signal S2 and obtain its communication content accordingly, such as voice information or digital data. The platform 160 may be a CPU (Central Processing Unit). The platform 160 is coupled to the SAR sensor 140 and the transceiver 150, and is configured to analyze all information from the SAR sensor 140 and the transceiver 150.

In the communication device 100 of the invention, the antenna is combined with the sensing pad, and they form a single radiation element 110. In addition, the RF choke element 120 and the DC block element 130 are used to filter input signals, and therefore the low-frequency signal S1 and the RF signal S2, received by the radiation element 110, are transmitted to the SAR sensor 140 and the transceiver 150, respectively. The above signals do not tend to interfere with each other. Since the antenna is integrated with the sensing pad, their total size can be further reduced. In comparison to the conventional design, the invention has at least the advantages of reducing the cost, minimizing the size, and enhancing the efficiency of using the elements.

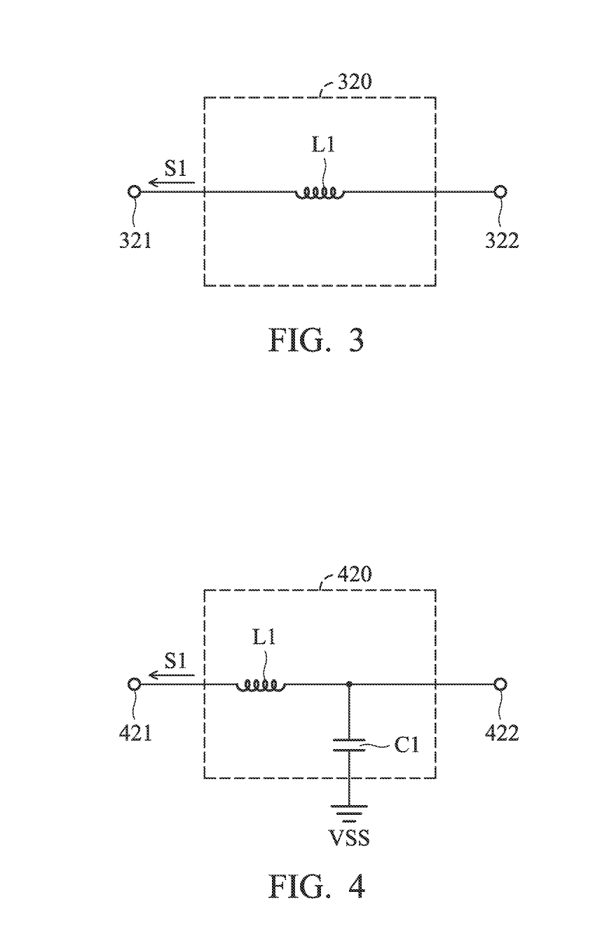

FIG. 3 is a diagram of an RF choke element 320 according to an embodiment of the invention. The RF choke element 320 of FIG. 3 may be applied to the communication device 100 of FIG. 1. The RF choke element 320 has a first terminal 321 coupled to the SAR sensor 140, and a second terminal 322 coupled to the radiation element 110. In the embodiment of FIG. 3, the RF choke element 320 includes an inductor L1. The inductor L1 is coupled between the first terminal 321 and the second terminal 322 of the RF choke element 320. The inductor L1 has a relatively large inductance. For example, the aforementioned inductance may be greater than or equal to 10 nH. The RF choke element 320 is configured to remove the RF signal S2 and retain the low-frequency signal S1.

FIG. 4 is a diagram of an RF choke element 420 according to an embodiment of the invention. The RF choke element 420 of FIG. 4 may be applied to the communication device 100 of FIG. 1. The RF choke element 420 has a first terminal 421 coupled to the SAR sensor 140, and a second terminal 422 coupled to the radiation element 110. In the embodiment of FIG. 4, the RF choke element 420 includes an inductor L1 and a capacitor C1. The inductor L1 is coupled between the first terminal 421 and the second terminal 422 of the RF choke element 420. The inductor L1 has a relatively large inductance. For example, the aforementioned inductance may be greater than or equal to 10 nH. The capacitor C1 is coupled between the second terminal 422 of the RF choke element 420 and a ground voltage VSS. In alternative embodiments, the capacitor C1 is coupled between the first terminal 421 of the RF choke element 420 and the ground voltage VSS. The RF choke element 420 is configured to remove the RF signal S2 and retain the low-frequency signal S1.

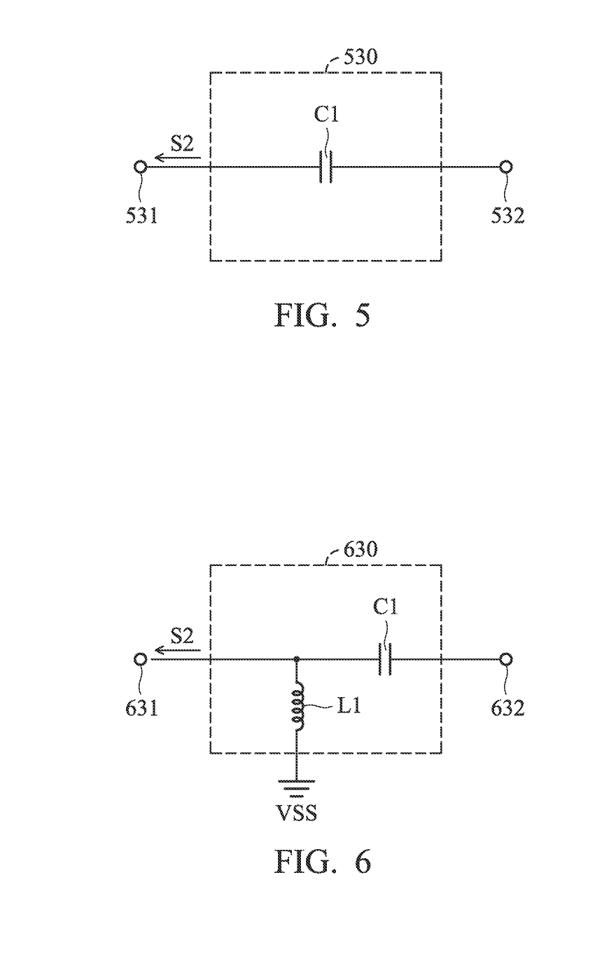

FIG. 5 is a diagram of a DC block element 530 according to an embodiment of the invention. The RF choke element 530 of FIG. 5 may be applied to the communication device 100 of FIG. 1. The DC block element 530 has a first terminal 531 coupled to the transceiver 150, and a second terminal 532 coupled to the radiation element 110. In the embodiment of FIG. 5, the DC block element 530 includes a capacitor C1. The capacitor C1 is coupled between the first terminal 531 and the second terminal 532 of the DC block element 530. The capacitor C1 has a relatively large capacitance. For example, the aforementioned capacitance may be greater than or equal to 10 pF. The DC block element 530 is configured to remove the low-frequency signal S1 and retain the RF signal S2.

FIG. 6 is a diagram of a DC block element 630 according to an embodiment of the invention. The RF choke element 630 of FIG. 6 may be applied to the communication device 100 of FIG. 1. The DC block element 630 has a first terminal 631 coupled to the transceiver 150, and a second terminal 632 coupled to the radiation element 110. In the embodiment of FIG. 6, the DC block element 630 includes a capacitor C1 and an inductor L1. The capacitor C1 is coupled between the first terminal 631 and the second terminal 632 of the DC block element 630. The capacitor C1 has a relatively large capacitance. For example, the aforementioned capacitance may be greater than or equal to 10 pF. The inductor L1 is coupled between the first terminal 631 of the DC block element 630 and a ground voltage VSS. In alternative embodiments, the inductor L1 is coupled between the second terminal 632 of the DC block element 630 and the ground voltage VSS. In other embodiments, the inductor L1 may be replaced with another capacitor C2 (not shown). The DC block element 630 is configured to remove the low-frequency signal S1 and retain the RF signal S2.

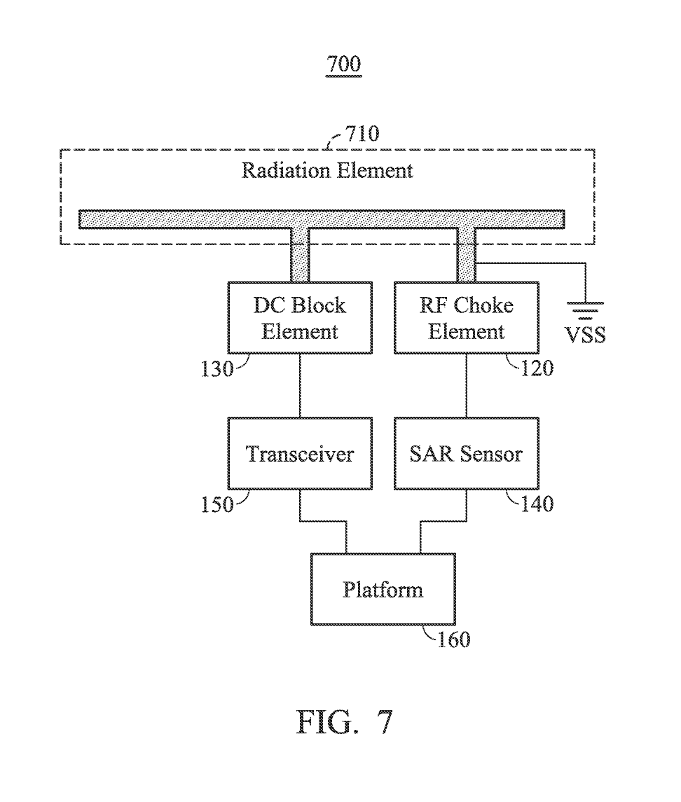

FIG. 7 is a diagram of a communication device 700 according to an embodiment of the invention. FIG. 7 is similar to FIG. 1. The difference between the two embodiments is that a radiation element 710 of the communication device 700 is a planar metal board, which is further coupled to a ground voltage VSS. A grounding point of the planar metal board may be positioned at a connection path between the radiation element 710 and the RF choke element 120. Other features of the communication device 700 of FIG. 7 are similar to those of the communication device 100 of FIG. 1. Accordingly, the two embodiments can achieve similar levels of performance.

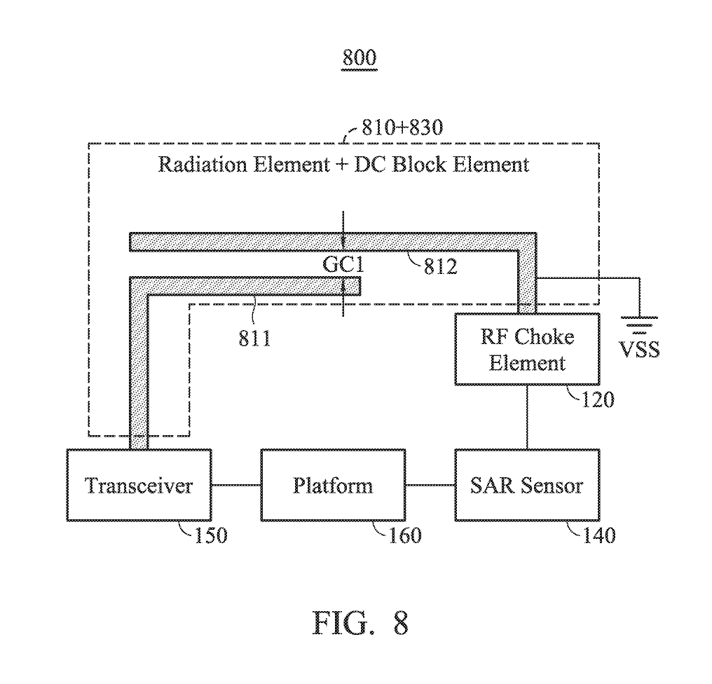

FIG. 8 is a diagram of a communication device 800 according to an embodiment of the invention. FIG. 8 is similar to FIG. 1. The difference between the two embodiments is that a radiation element 810 and a DC block element 830 of the communication device 800 are implemented with a first metal element 811 and a second metal element 812. The first metal element 811 is separate from the second metal element 812. The first metal element 811 may substantially have an L-shape. The second metal element 812 may substantially have another L-shape. The length of the second metal element 812 may be longer than that of the first metal element 811. The first metal element 811 is close to the second metal element 812, and a coupling gap GC1 is formed between the first metal element 811 and the second metal element 812. The width of the coupling gap GC1 may be shorter than 2 mm. The first metal element 811 is coupled to the transceiver 150. The second metal element 812 is coupled to the RF choke element 120 and a ground voltage VSS. Other features of the communication device 800 of FIG. 8 are similar to those of the communication device 100 of FIG. 1. Accordingly, the two embodiments can achieve similar levels of performance.

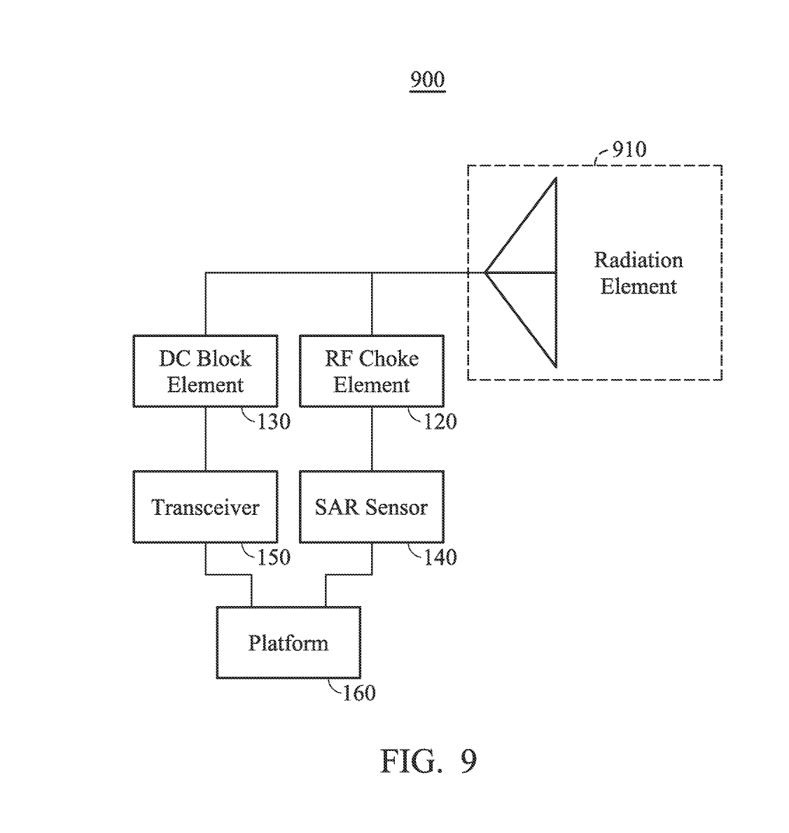

FIG. 9 is a diagram of a communication device 900 according to an embodiment of the invention. FIG. 9 is similar to FIG. 1. The difference between the two embodiments is that a radiation element 910 of the communication device 900 is a metal element having any shape. For example, the metal element may substantially have a triangular shape, a circular shape, an elliptical shape, a rectangular shape, or a trapezoidal shape. Other features of the communication device 900 of FIG. 9 are similar to those of the communication device 100 of FIG. 1. Accordingly, the two embodiments can achieve similar levels of performance.

The invention proposes a novel communication device with a compound element including an antenna and a sensing pad. In addition, an RF choke element and a DC block element are used, and therefore the invention can not only avoid signal interference but also reduce design space.

Note that the above element sizes, element shapes, and frequency ranges are not limitations of the invention. An antenna engineer can adjust these settings or values according to different requirements. It should be understood that the communication device of the invention is not limited to the configurations of FIGS. 1-9. The invention may merely include any one or more features of any one or more embodiments of FIGS. 1-9. In other words, not all of the features shown in the figures should be implemented in the communication device of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

1. A communication device, comprising:
a radiation element, having functions of both an antenna and a sensing pad, and configured to receive a low-frequency signal and an RF (Radio Frequency) signal;
an RF choke element, configured to remove the RF signal;
a DC (Direct Current) block element, configured to remove the low-frequency signal;
an SAR (Specific Absorption Rate) sensor, wherein the radiation element is coupled through the RF choke element to the SAR sensor;
a transceiver, wherein the radiation element is further coupled through the DC block element to the transceiver; and
a platform, coupled to the SAR sensor and the transceiver;
wherein the radiation element has a grounding point which is directly connected to a ground voltage.

2. The communication device as claimed in claim 1, wherein the SAR sensor is configured to process the low-frequency signal and obtain SAR information thereof accordingly.

3. The communication device as claimed in claim 1, wherein when a human body is close to the radiation element, an effective capacitance is formed between the radiation element and the human body, wherein the low-frequency signal comprises information of the effective capacitance.

4. The communication device as claimed in claim 1, wherein the transceiver is configured to process the RF signal and obtain a communication content thereof accordingly.

5. The communication device as claimed in claim 1, wherein the RF choke element comprises an inductor, and the inductor has a relatively large inductance.

6. The communication device as claimed in claim 1, wherein the DC block element comprises a capacitor, and the capacitor has a relatively large capacitance.

7. (canceled)

8. The communication device as claimed in claim 1, wherein the radiation element and the DC block element are implemented with a first metal element and a second metal element, wherein the first metal element is separate from the second metal element.

9. The communication device as claimed in claim 8, wherein the first metal element is close to the second metal element, and a coupling gap is formed between the first metal element and the second metal element.

10. The communication device as claimed in claim 8, wherein the second metal element is coupled to the RF choke element and a ground voltage.
